(19) United States
(12) Patent Application Publication
(10) Pub. No.: US 2007/0114288 A1
(43) Pub. Date: May 24, 2007

(54) System and method for implementing an action based on a written mark

(75) Inventors: Gregory M. Sparzo, Cheshire, CT (US); Henry Osborne, Granby, CT (US)

Correspondence Address: ST. ONGE STEWARD JOHNSTON & REENS, LLC, 986 BEDFORD STREET, STAMFORD, CT, 06905-5619, US

(73) Assignee: Penable Digital Solutions, LLC, Cheshire, CT (US)

(21) Appl. No.: 11/352,602

(22) Filed: Feb. 13, 2006

Related U.S. Application Data
(60) Provisional application No. 60/738,060, filed on Nov. 21, 2005.

(51) Int. Cl. G06K 7/10

(52) U.S. Cl. 235/472.03

(57) ABSTRACT

A system for implementing an action based on written mark, including a writable surface having one or more predefined locations thereon for receiving a written mark, a device for making the written mark on the writable surface and reading information, the information including both the written mark and the location in which it is made, and software executing on a controller for implementing an action upon reading the information, the action being based on the read information and information from at least one other source.

### CROSS-REFERENCE TO RELATED APPLICATIONS

This application claims priority benefits under 35 § U.S.C. 119(e) of the U.S. Provisional Application No. 60/738,060, filed on Nov. 21, 2005.

### FIELD OF THE INVENTION

The invention relates to electronic reading and reporting of information, and more specifically to a system and method for the reading and reporting information in response to a written mark.

### BACKGROUND OF THE INVENTION

Some writing devices or digital pens capable of recording handwritten marks made on position-coded paper are known in the art. Such writing devices generally detect position codes on the paper where the mark is made in order to electronically record the mark. Methods of recording and communicating handwritten information are similarly known. For example, U.S. Pat. No. 6,698,660 discloses a method of recording and managing information wherein information is written on a surface using a handheld writing device and recorded electronically. The information may then be interpreted via optical character recognition, refined and transmitted to a storage or addressee.

While such known devices and methods provide for the translation of handwritten information, there is a need for systems to receive information from multiple devices and/or multiple surfaces and effectively manage and execute actions based on received information. What is desired therefore is a system for processing data received from multiple digital pens and/or multiple surfaces and automatically executing actions.

### SUMMARY OF THE INVENTION

According, it is an object of the present invention to provide a system and method for automatically implementing one or more actions based on written marks. It is a further object to provide a system and method of aggregating information from any number of writing devices, forms, and/or databases and executing actions based on the aggregated information such as deploying reports and dashboards to a client company's management in real time. It is a further object to provide a system and method for triggering processes, macros, stored procedures and other actions to convert the aggregated information into actionable information in real time.

These and other objects of the present invention are achieved by providing a system a system for implementing an action based on written mark, including a writable surface having one or more predefined locations thereon for receiving a written mark, a device for making the written mark on the writable surface and reading information, the information including both the written mark and the location in which it is made, and software executing on a controller for implementing an action upon reading the information, the action being based on the read information and information from at least one other source.

Further provided is a system for implementing an action based on written mark, including a writable surface having two or more predefined locations thereon for receiving written marks, a device for making a first written mark in a first location and a second written mark in a second location, and for reading first information from the first location and second information from the second location, the first and second information each including both the respective written mark and the respective location in which it was made, software executing on a controller for interpreting the first information, a database including a plurality of fields, software executing on the controller for storing at least a portion of the second information in a field corresponding to the second location, and software executing on the controller for implementing an action represented by the interpreted first information.

Further provided is a method of implementing an action based on a written mark, including the steps of making a written mark to one or more predefined locations of a writable surface, receiving information from the writable surface, interpreting the information, storing the information in a field of a database, the field corresponding to the location in which the written mark was made, and implementing an action based on the information and information stored in the database from at least one other source.

### BRIEF DESCRIPTION OF THE DRAWINGS

FIG. 1 is a schematic view of a system for implementing an action in response to a written mark in accordance with present invention.

FIG. 2 is another schematic view of a system for implementing an action in response to a written mark in accordance with present invention.

FIG. 3A is side view of a device for making a mark and reading information in accordance with the present invention.

FIG. 3B is front view of an exemplary device for making a mark and reading information in accordance with the present invention.

FIG. 4A is schematic view of an exemplary writable surface in accordance with the present invention.

FIG. 4B is schematic view of an exemplary writable surface in accordance with the present invention.

FIG. 4C is schematic view of an exemplary writable surface in accordance with the present invention.

FIG. 4D is schematic view of an exemplary writable surface in accordance with the present invention.

FIG. 5 is schematic view of an exemplary report in accordance with the present invention.

FIG. 6 is method for implementing an action in response to a written mark employable by the system shown in FIGS. 1-2.

FIG. 7 is another method for implementing an action in response to a written mark employable by the system shown in FIGS. 1-2.

### DETAILED DESCRIPTION OF THE DRAWINGS

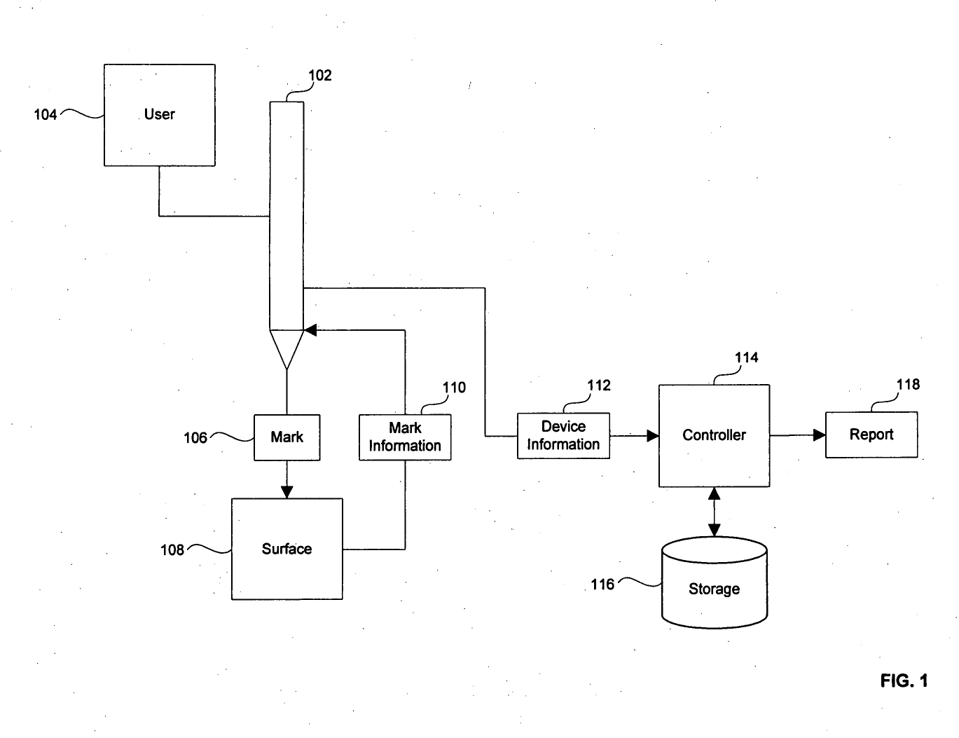

FIG. 1 shows a schematic view of a system for implementing an action in response to a written mark in accordance with present invention. The system includes at least one writing device 102. The writing device 102 may be any known writing device or digital pen for making a mark 106 on a surface 108 and reading information from the surface 108. For example, the writing device 102 may be a Logitech® digital pen. The writing device 104 may be activated and/or manipulated by a user 104.

The surface 108 according to the present invention may be position-coded paper or any other surface including position-coding. For example, the surface 108 may be position-coded paper as manufactured or licensed by Anoto®. The surface 108 may further be a form customized for a particular type of data entry and/or action. As such, the surface 108 may have any number of predefined locations for receiving a written mark. For example, the surface 108 may be a product order form. In other embodiments, the surface 108 may be one surface of product container having position-coding thereon.

As shown in FIG. 1, the system of the present invention further includes a controller 114. The controller 114 may be any device, system, or part thereof that controls at least one operation or receives and/or execute one or more software programs. The controller 114 may, for example, be one of a digital signal processor, a microcontroller, a microprocessor, or a computer programmable logic device. It should be noted that the functionality associated with the controller 114 may be centralized or distributed, whether locally or remotely. Mark information 110 including the written mark and the location in which it was made is received (e.g., read) by the writing device 102. The controller 114 of system may then receive information 112 (e.g., device information) from the writing device 102 either periodically in a batch or in real time (e.g., wirelessly). The device information 112 includes the mark information 110 and, in some cases, other information stored in the writing device 102. For example, the device information 112 may include mark information stored from a previous mark. The device information 112 may further include information identifying the device 102 and/or a user 104 of the device 102.

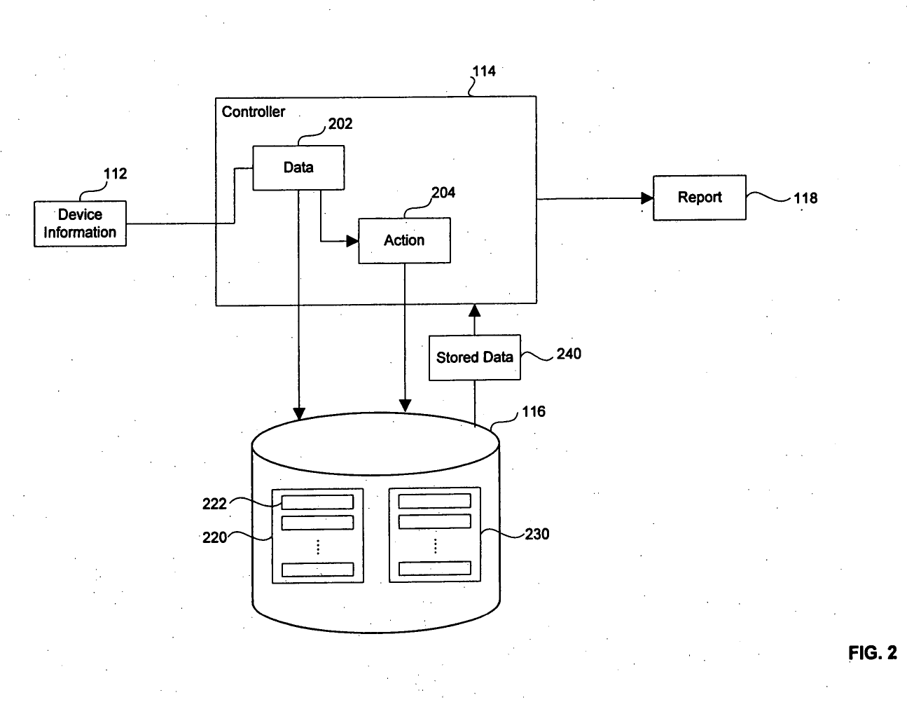

The controller 114 may include software for executing an action from the mark information 110 and/or device information 112. Shown in FIG. 2, the controller 114 may receive the device information 112 and identify data 202 for storage and/or an action 204 for implementation. An identified action 204 is preferably based on or related to the mark information 110 and information from at least one other source. For example, the action 204 may be also based on other information stored in the writing device 102 such as information received from a second surface. The action 204 may further be based on or related to information from a second writing device and/or information stored in a database.

Shown in FIGS. 1 and 2, the system further includes at least one storage 116. The storage 116 may include any number of data records, e.g., data records 220 and 230. Each data record 220/230 may also include any number of data fields, e.g., 222, for storing portions of the information 110/112. The system also includes software executing on the controller 114 for storing a portion of the information 110/112 in a data field corresponding to a location on the surface 108 in which the written mark 106 was made. The storage 116 (and/or data records or fields thereof) further includes information from at least one other source (e.g., surface, device, and/or user).

Data or information in the storage 116 may be organized in any manner, such as by information category. For example, the storage 116 may be organized by user, by writing device, and/or by surface. The storage 116 may further be organized by accounts associated or indicated in read information and/or managers or subscribers of the particular accounts. In one exemplary embodiment, the storage 116 may include at least one data record for each of a group of sales representatives. Each data record my also be grouped by a particular manager associated with the group of sales representatives.

As discussed above, the controller 104 receives device information 112 including data 202 for storage and/or actions (e.g., 204) for implementation. The action 204 to be implemented by the system may include any number of actions triggered by and/or based on the read information 110/112. For example, the action 204 may include aggregating data (e.g., from the device 102 and/or other sources) and generating or updating a report 118. The report 118 may be a written report, electronic mail, dashboard display, text message, audible transmission, or any other type of report. In some embodiments, the system may generate a report 118 including a category of information from the storage 116 (e.g., stored data 240). For example, the system may periodically and/or in real time generate and distribute a report 118 to subscriber of one or more categories of information. For example, in one embodiment the present invention allows a manager to receive real time reports of the activities of a group of sales representatives. Such reports communicate real time sales made by each representative and/or total sales for a given time period or product. The reports may further indicate the client locations and times of sales and therefore the location and working hours of particular sales representatives or real time verification that a critical task has been completed.

The action 204 may further include storing a portion of the device information 112 and/or data 202 in a particular location of the storage 116. For example, a portion of the surface 108 may be indicative of a field (e.g., 222) of the storage 116. The action 204 may therefore include storing a portion of the device information 112 and/or data 202 in the particular field. In some embodiments, the stored data 202 further includes a record of completed action or an action to be implemented. Further, the device information 112 may include other indicators of particular storage locations. For example, the text of the written mark may include a customer or account name interpreted by the controller 114 to indication association with one or more data records. As discussed above, the device information 112 may also including information about the writing device 102 or a user 104 thereof which may also indicate particular storage locations or other actions to be taken.

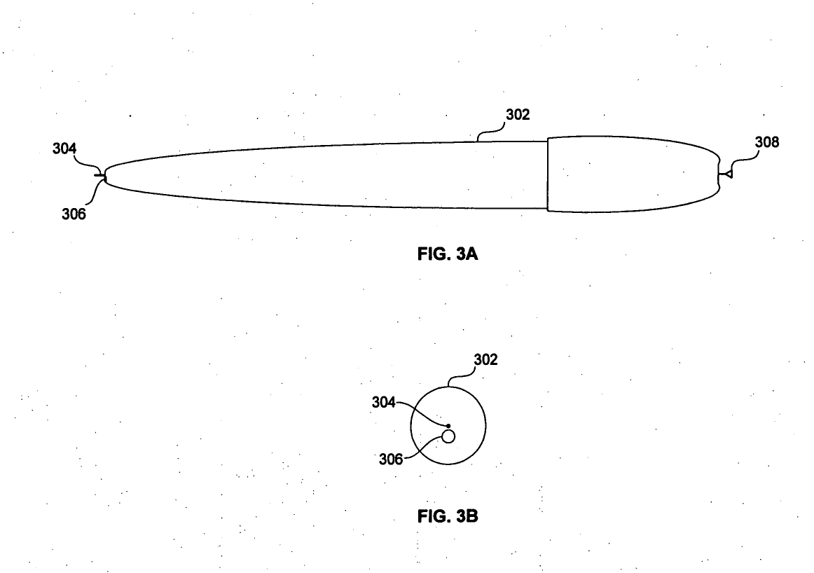

FIGS. 3A and 3B show an exemplary device 302 for making a mark and reading information in accordance with the present invention. The device 302 includes a writing element 304 such an ink and or graphite tip. The device 302 further includes an optical element 306 for receiving and/or reading the mark 106 and the location in which it is made. The device 302 may also include a device storage (not shown). In some embodiments, the device 302 communicates device information (e.g., 112) via a docking station. However, the device 302 according to the present invention preferably includes an antenna 308 (either internal or external) to enable wireless communication of information. The device 302 may communicate via any known wireless means including, but not limited to, Bluetooth®, Wi-Fi (e.g., including long range broadband communication), RF, PCS, and/or cellular.

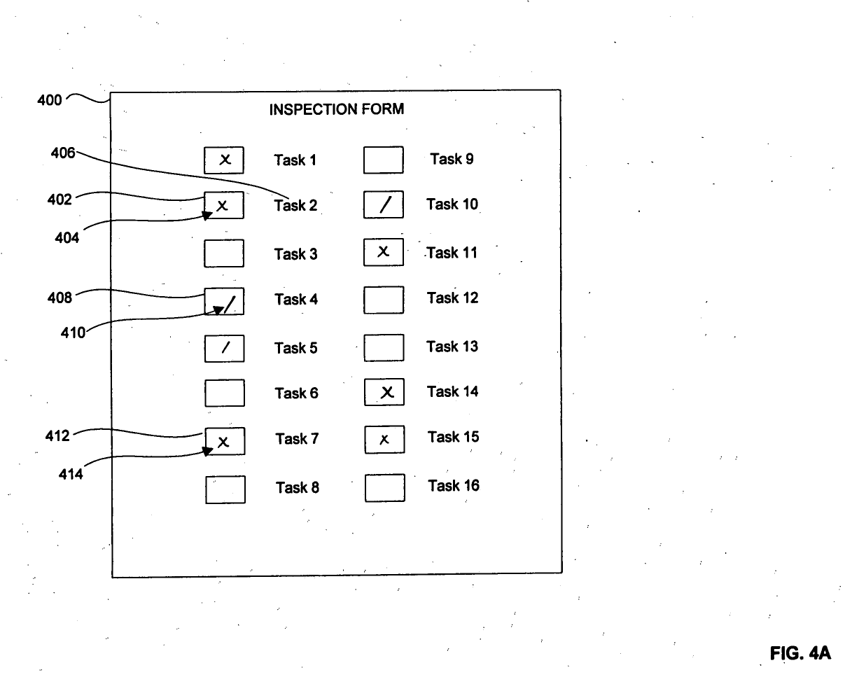

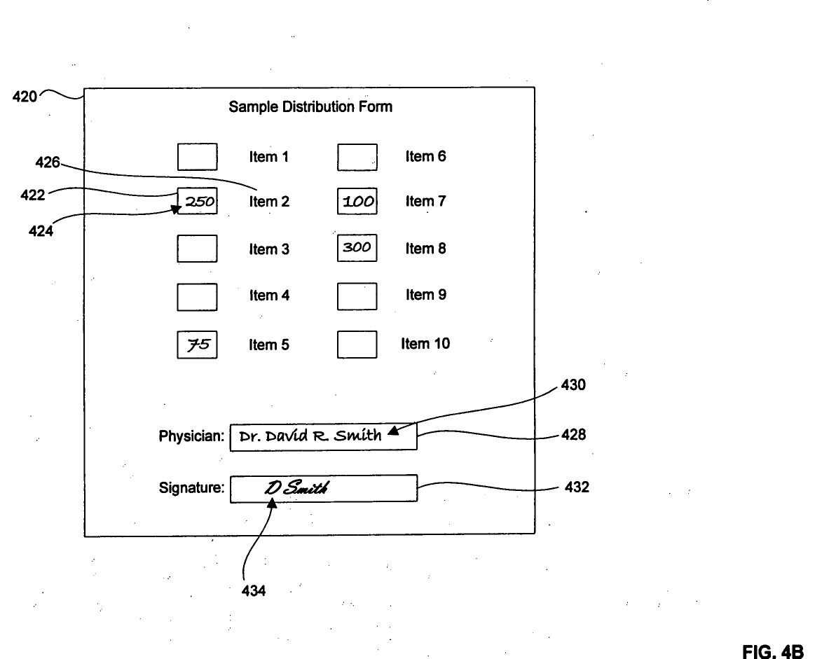

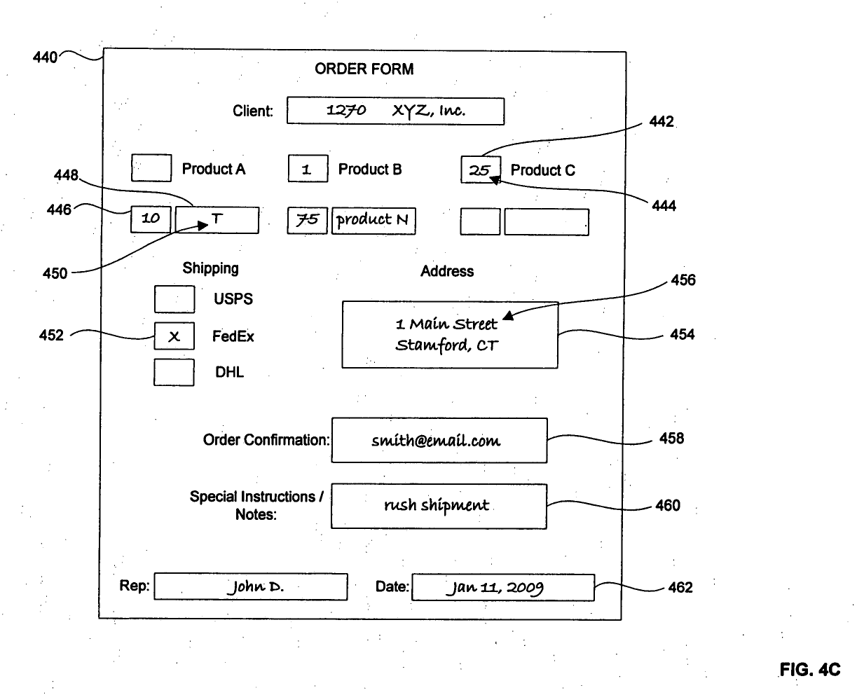

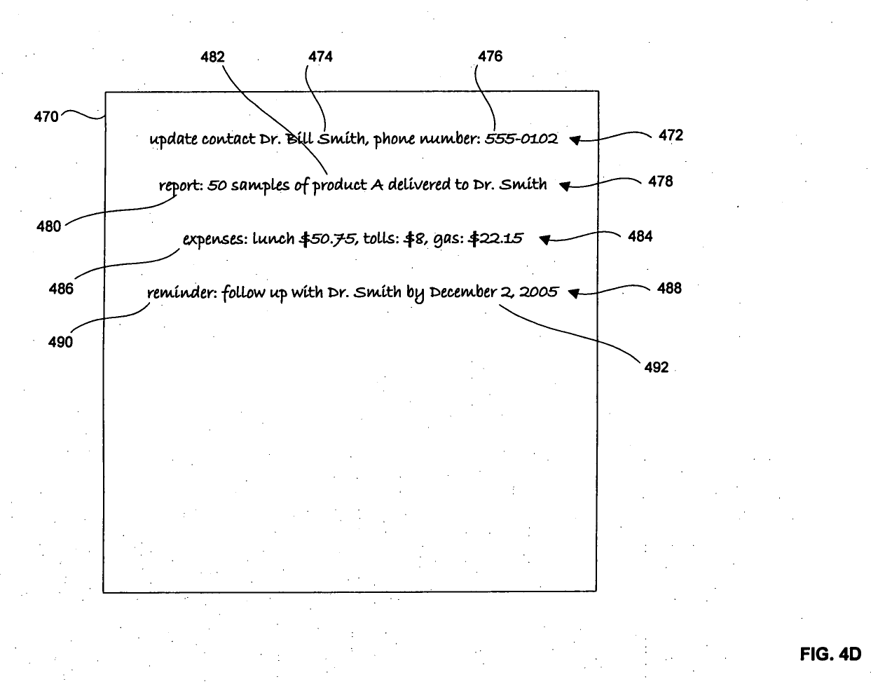

FIGS. 4A-4D show several exemplary surfaces or forms according to the present invention. It should be noted, however, that these forms are only exemplary and many other customized forms may be employed by the present invention. FIG. 4A shows a surface or form 400 according to the present invention. The form 400 may, for example, be an inspection form. The form 400 includes any number of locations such as location 402, 408 and 412. As shown, a mark 404 may be made in the location 402. Upon making the mark 404, the writing device 102 may receive mark information 110 including the mark 404 and indication of the location 402 in which it was made. In this particular example, the location 402 is indicative of the completion of a “Task 2.”

The controller 114, upon receiving device information 112 containing such mark information 110, may implement a corresponding action. For example, the controller 114 may generate a report evidencing the completion of the Task 2. The controller 114 may further access stored data 240 for use in implementing the action. In this case, the stored data 240 may include further information related to the Task 2, the user 104, information regarding the type of report to generate and/or the proper recipients of the report. The generated report may therefore include information related to other tasks completed by the user and/or other instances of the task 2 being completed (e.g., by any user).

FIG. 4B shows another exemplary surface or form 420 according to the present invention. The form 420 is a sample distribution form such as one which may be used in the pharmaceutical industry. The form 420 includes any number of locations, e.g., 422, 428, 432 for receiving a mark (e.g., 424). Mark information received from some of the locations may be interpreted for inclusion of an action, while mark information from some other locations may only be stored. For example, the mark 424 in location 422 may be indicative of an action, such as to generate (e.g., or update) a report evidencing all distributions of item 2. In some other embodiments, such a mark 424 may indicate an action to deliver 250 item 2s to the physician indicated therein and/or replenish inventory of item 2. Another mark 434 made in the location 432 may only be stored (e.g., as an image file) with a data record associated with the user, the physician and/or items (e.g., 2, 5, 7, and/or 8). In other embodiments, the presence of a mark 434 (e.g., signature) in the location 432 may trigger any number of actions.

FIG. 4C shows another exemplary surface or form 440 according to the present invention. The form 440 may be a product order form. The form 470 includes any number of locations (e.g., 442, 446, 452, 454, 458, 460, and 462). A mark made in at least some of the locations may be interpreted to determine an action. For example, a mark made in the location 452 may indicate that a product identified elsewhere on the form is to be delivered via FedEx. The mark may further trigger an action to retrieve stored data such as a FedEx account number for the client identified elsewhere on the form. Marks made in at least some other locations may only be read and stored. For example, a mark made in location 462 may only be stored with a report associated with the order, representative or client.

FIG. 4D shows another exemplary surface 470 according to the present invention. The surface 470 does not include particular locations for the receipt of written marks. Alternatively, the system may interpret all mark information received from the surface 470 to determine actions contained therein. A user may write a mark 472 including at least code or symbol indicative of an action to be implemented upon interpretation by the controller. For example, the code or code words “update contact” may indicate that the following portion of the mark is to be saved in a contact (e.g., Outlook or Entourage contact) for an identified individual (e.g., Dr. Bill Smith). Other codes may indicate other actions such as to generate a report of a product distribution (e.g., mark 478), to generate an expense report (e.g., mark 484), and to generate a reminder (e.g., Outlook or Entourage reminder).

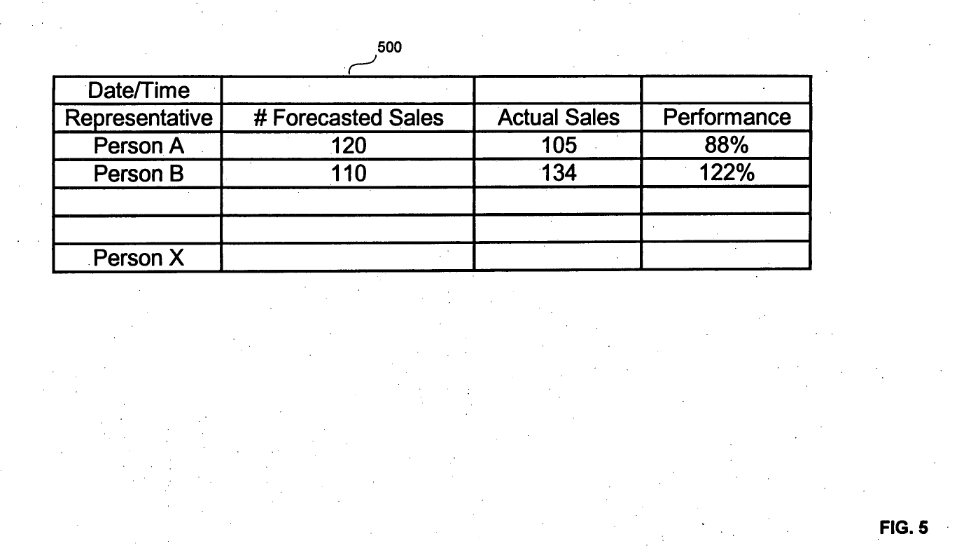

FIG. 5 shows an exemplary report 500 according to the present invention. The report 500 may be generated or updated upon the receipt of device information evidencing a sale made by any one a group of sales representatives. For example, upon each sale made by a representative, a manager may be sent such a report 500 in real time including past and present sales data for the group. Further, the report 500 may be in the form of a dashboard displayed on the manager's desktop being updated in real time as each sale is executed.

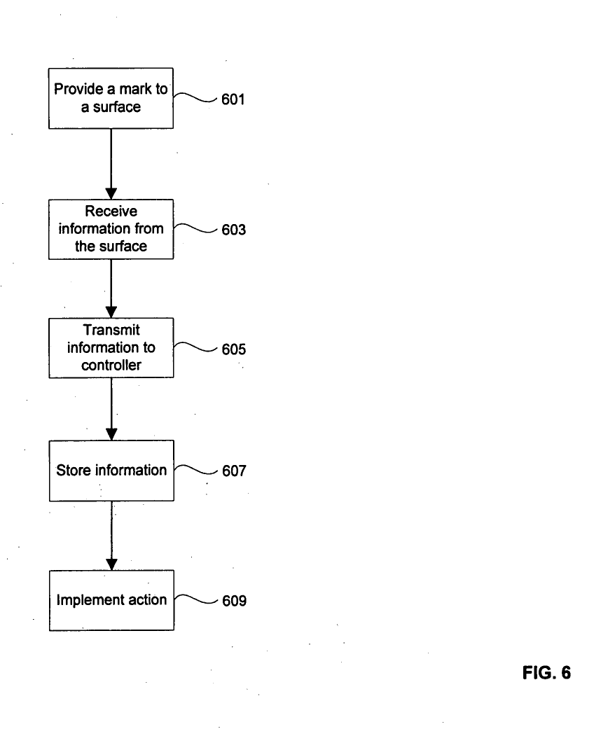

FIG. 6 shows one exemplary method of implementing an action in response to a written mark. In a first step, a mark is provided to a surface and/or form as described herein (step 601). Information is then received from the surface, e.g., including the written mark and the location in which it was made (step 603). The information may be transmitted to the controller and stored (step 605-607). An action is then implemented (step 609). The present may be useful when the location of a mark alone provides the information necessary to implement an action. For example, a mark made in the location 402 of the form 400 may indicate that a report evidencing the completion of the task 2 is to be generated.

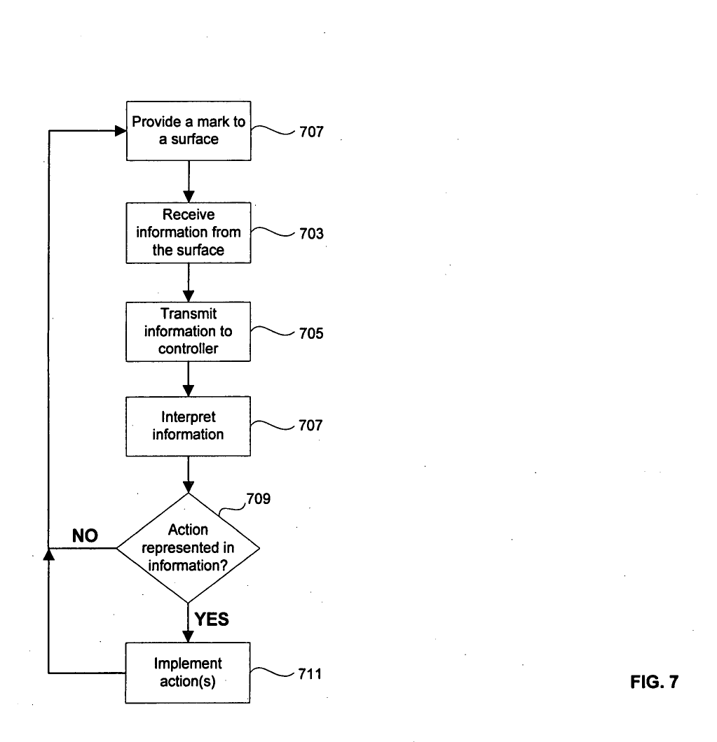

FIG. 7 shows another exemplary method of implementing an action in response to a written mark. In a first step, a mark is provided to a surface and/or form as described herein (step 701). Information is then received from the surface, e.g., including the written mark and the location in which it was made (step 703). The information is then transmitted to the controller and interpreted (step 705-607). For example, the controller may interpret the information to determine if the information includes an indicator (e.g., code) of a particular action. Any actions represented by the information may then be implemented (step 711).

In operation, the present invention may, for example, be useful in the pharmaceutical industry. As those in the industry will appreciate, pharmaceutical sale representatives visit numerous health care practitioners on a daily basis. The representatives often distribute samples of various pharmaceuticals to the practitioners as well. Each distribution must be documented and recorded. Therefore, representatives often fill out a form evidencing each distribution and including the practitioner's signature.

The present invention therefore may provide numerous advantages in this industry. First, a customized form may be used for evidencing the distribution (e.g., form 420). In some embodiments, the surface 108 may simply be the box or container in which the distributed sample is contained. The writing device 102 may record information relating the distribution, e.g., including the practitioner's signature, and wirelessly transmit it to a remotely located controller and/or server for processing and storage. The controller 114 may receive the information and store at least a portion of the information. For example, the controller 114 may identify the user (i.e., sales representative), the practitioner, and the quantities and types of distributed samples. The controller 114 may then store the information accordingly, e.g., in data records associated with one or all of the particular user, practitioner, type of sample (e.g., pharmaceutical), and/or data records.

The controller 114 may also generate and distribute reports based on device information and/or information from at least one other source (e.g., a second representative, a second device, a second form, etc). For example, the controller 114 may generate a report of each representative's distributions over a period of time. A manager of the representatives may then receive real time reports and/or updated reports on the progress and activities of each representative (e.g., report 500). The frequency and content of the reports may be dictated by the manager's system preferences (e.g., set via a user interface) and/or predefined business rules.

Although the invention has been described with reference to a particular arrangement of parts, features and the like, these are not intended to exhaust all possible arrangements or features, and indeed many modifications and variations will be ascertainable to those of skill in the art.

What is claimed is:

1. A system for implementing an action based on written mark, comprising:
a writable surface having one or more predefined locations thereon for receiving a written mark;
a device for making the written mark on the writable surface and reading information, the information including both the written mark and the location in which it is made; and
software executing on a controller for implementing an action upon reading the information, the action being based on the read information and information from at least one other source.

2. The system according to claim 1, wherein the other source is one of a second device, a second writable surface, or a database.

3. The system according to claim 1, further comprising:
a database including a plurality of fields; and
software executing on the controller for storing at least a portion of the information in a field corresponding to the location in which the written mark was made.

4. The system according to claim 3,
wherein said database includes the information from the at least one other source, and
wherein the action includes aggregating the read information and the information from at least one other source by category.

5. The system according to claim 4, wherein the action further includes generating a report of one or more of the categories.

6. The system according to claim 5, wherein the action further includes automatically distributing the report to one or more subscribers of the category.

7. The system according to claim 1, wherein said writable surface is a form for reporting the completion of one or more tasks.

8. The system according to claim 1, wherein said writable surface is a form for recording a distribution.

9. The system according to claim 1, said device including a memory for storing the read information.

10. The system according to claim 9, the memory including information stored from multiple writable surfaces.

11. The system according to claim 9, further comprising:
a communication link for wirelessly transferring the information from the memory.

12. The system according to claim 1, wherein the action includes generating a report including the read information and information from the at least one other source.

13. The system according to claim 12, wherein the report includes a information associated with one of a particular user, a particular group of users, or a particular account.

14. The system according to claim 13, wherein the report is distributed to one or more managers of the particular user, group, or account.

15. A system for implementing an action based on written mark, comprising:
a writable surface having two or more predefined locations thereon for receiving written marks;
a device for making a first written mark in a first location and a second written mark in a second location, and for reading first information from the first location and second information from the second location, the first and second information each including both the respective written mark and the respective location in which it was made;
software executing on a controller for interpreting the first information;
a database including a plurality of fields;
software executing on the controller for storing at least a portion of the second information in a field corresponding to the second location; and
software executing on the controller for implementing an action represented by the interpreted first information.

16. The system according to claim 15, wherein said software for storing further storing at least a portion of the first information in a field corresponding to the first location.

17. The system according to claim 15,
wherein said database includes information from at least one other source, and
wherein the action includes aggregating the second information and the information from at least one other source by category.

18. The system according to claim 17, wherein the action further includes generating a report of one or more of the categories.

19. The system according to claim 18, wherein the report is generated upon the receipt of a new written mark.

20. The system according to claim 17, wherein the other source is one of a second device, a second writable surface, or a second database.

21. The system according to claim 15, wherein each of the one or more predefined locations on said writable surface comprise a position-coding pattern for defining the predefined locations on the writable surface.

22. The system according to claim 21, wherein at least a portion of the position-coding pattern is indicative of a field in the database.

23. The system according to claim 15, wherein said writable surface is a form for recording a distribution.

24. The system according to claim 15, wherein said writable surface is a form for executing a sale.

25. The system according to claim 24, wherein the action includes executing a sale.

26. The system according to claim 15, wherein the action includes replenishing inventory.

27. A system for implementing an action based on a written mark, comprising:
a writable surface for receiving a written mark;
a device for making the written mark on the writable surface and reading information, the information including the written mark;
software executing on a controller for interpreting the information;
a database including a plurality of fields;
software executing on the controller for storing at least a portion of the information in a field of the database; and
software executing on the controller for implementing an action represented by the information.

28. The system according to claim 27,
wherein said database includes information from at least one other source, and
wherein the action includes aggregating the read information and the information from at least one other source by category.

29. The system according to claim 28, wherein the action further includes generating a report of one or more of the categories.

30. The system according to claim 28, wherein the other source is one of a second device, a second writable surface, or a second database.

31. The system according to claim 27, wherein said writable surface includes a position-coding pattern for defining a position on the writable surface.

32. The system according to claim 31, wherein said software for interpreting the written mark interprets the written mark based on the positions in which the mark in made.

33. The system according to claim 27, wherein the written mark includes a written code indicative of the action.

34. The system according to claim 33, wherein said software for interpreting the written mark further decodes the written code.

35. The system according to claim 27, wherein the action is generating a report.

36. The system according to claim 35, wherein the report is generated upon the receipt of a new written mark.

37. The system according to claim 27, wherein the action is generating an updated report.

38. The system according to claim 27, the action including updating information in said database.

39. The system according to claim 27, wherein the action is updating information in a dashboard.

40. The system according to claim 27, wherein the action is replenishing inventory.

41. A method of implementing an action based on a written mark, comprising the steps of:
making a written mark to one or more predefined locations of a writable surface;
receiving information from the writable surface;
interpreting the information;
storing the information in a field of a database, the field corresponding to the location in which the written mark was made; and
implementing an action based on the information and information stored in the database from at least one other source.

42. The method according to claim 41, wherein the other source is one of a device, a second writable surface, or a second database.
